(19) United States
(12) Patent Application Publication
(10) Pub. No.: US 2011/0120502 A1
(43) Pub. Date: May 26, 2011

(54) Substrate Washing Apparatus and Methods of Use

(75) Inventors: Abraham Anapolsky, San Mateo, CA (US); Dhruv Gajaria, Mountain View, CA (US)

(73) Assignee: Applied Materials, Inc., Santa Clara, CA (US)

(21) Appl. No.: 12/624,692

(22) Filed: Nov. 24, 2009

(51) Int. Cl. B08B 3/00

(52) U.S. Cl. 134/26; 134/61

(57) ABSTRACT

Embodiments of the invention generally relate to apparatus and methods for washing substrates. In particular, apparatus and methods for washing solar cell substrates are described, the apparatus including a detergent mixing circuit to control detergent concentration during washing.

### BACKGROUND

1. Field of the Invention

Embodiments of the present invention relate generally to the field of semiconductor preparation. More specifically, embodiments of the invention are directed to apparatus and methods for washing substrates before, during and after processing.

2. Background of the Related Art

During semiconductor processing, it can be important to start with a clean substrates. When substrates are not clean, or are not evenly cleaned, the quality of films deposited on such surfaces suffers. Therefore, it is important to have a uniformly clean surface for semiconductor processing.

Generally, photovoltaic cells are too large to be immersed into cleaning solution baths. Therefore, it can be important to maintain careful control over the concentration of detergent in the cleaning solutions.

Currently, glass and substrate materials are washed by dispensing detergent into reservoir tanks. Convective mixing is relied on for mixing the detergent solution. This results in an inhomogeneous concentration of detergent throughout the bath. Current detergent/chemical control circuits on washers rely on pH, conductivity or density with a control system to control the concentration of the detergent mixture in the washer tank. Many washing systems use no monitoring system at all.

Buffered chemical solutions are extremely difficult to control by relying on solution pH or conductivity. Moreover, pH sensors are not very reliable for long term production use. Therefore, there is a need in the art for apparatuses and methods for cleaning substrates that allow for better control over the concentration of detergent.

### SUMMARY

One or more embodiments of the invention are directed to apparatuses for cleaning substrates. The apparatuses comprise a wash tank having a detergent section and a rinse section. The wash tank has a plurality of walls defining a wash tank area. A transport unit is configured to advance the substrate from a position outside the wash tank area to a position over the detergent section of the wash tank to a position over the rinse section of the wash tank and to a second position outside of the wash tank area. The apparatuses include an incoming water source supplying a flow of water to the rinse section of the wash tank. A rinse section sprayer in flow communication with the incoming water source is positioned above the rinse section of the wash tank. The rinse section sprayer is configured to spray water from the incoming water source over a surface of a substrate when the substrate is positioned over the rinse section of the wash tank. A recirculator is configured to move water from the rinse section to the detergent section. A detergent source is in flow communication with the recirculator. The detergent source supplies a volume of detergent to the water entering the detergent section. A detergent section sprayer is in flow communication with the recirculator and is positioned above the detergent section of the wash tank. The detergent section sprayer is configured to spray water from the recirculator over a surface of a substrate when the substrate is positioned over the detergent section of the wash tank.

Detailed embodiments further comprise a metering device on the incoming water source. The metering device being configured to control the flow of water added to the rinse section of the wash tank.

In specific embodiments the incoming water source comprises a rinse tank, the rinse tank including a clean water source.

In one or more embodiments, the detergent source further comprises a detergent metering device configured to control the amount of detergent supplied to the water entering the detergent section of the wash tank. According to detailed embodiments, the detergent metering device comprises a dosing pump.

Some detailed embodiments further comprise a partition separating the detergent section of the wash tank from the rinse section of the wash tank. In specific embodiments, the partition separating the detergent section from the rinse section is taller than at least one wall of the wash tank area adjacent the rinse section to prevent an overflow of water from the rinse section from entering the detergent section.

One or more embodiments further comprise a waste line configured to flow water from the detergent section of the wash tank. In detailed embodiments, the waste line flows water from the detergent section of the wash tank to one or more of a drain or a separate tank. In specific embodiments, the waste line further comprises a waste metering device configured to control the flow of water through the waste line from the detergent section of the wash tank.

Additional embodiments of the invention are directed to methods of cleaning a surface of a substrate. The substrate is conveyed through a washing apparatus including a detergent wash section and a first rinse section. Water is directed from the first rinse section to the detergent wash section. A detergent is mixed with the water from the first rinse section to make a detergent wash. The surface of the substrate is washed with the detergent wash. The substrate is positioned in the first rinse section and water is directed to the first rinse section from a separate water source. The surface of the substrate is rinsed with water from the separate water source.

In detailed embodiments, the separate water source is a separate rinse section.

According to one or more embodiments, washing the surface of the substrate with the detergent wash comprises forcefully spraying the detergent wash over the surface. In detailed embodiments, rinsing the surface of the substrate comprises forcefully spraying water over the surface.

In specific embodiments, an amount of water directed from the first rinse section is determined based on evaporation of water from the detergent wash section.

Further embodiments of the invention are directed to apparatuses for cleaning substrates. The apparatuses include a rinse tank section having a rinse tank and a clean water source. The rinse tank section including a rinse tank sprayer in flow communication with the clean water source, the rinse tank sprayer configured to spray water over a surface of a substrate when the substrate is positioned over the rinse tank. The apparatuses include a wash tank having a detergent section and a rinse section. The wash tank having a plurality of walls defining a wash tank area and a dividing wall separating the detergent section from the rinse section. A rinse tank water line is in flow communication with the rinse tank. The rinse tank water line including a rinse section sprayer in flow communication with the rinse tank water line. The rinse section sprayer is configured to spray water over the substrate surface when the substrate is positioned over the rinse section of the wash tank. A detergent water line is in flow communication with the rinse section of the wash tank and is configured to move water from the rinse section to the detergent section. A detergent source is in flow communication with the detergent water line. The detergent source includes a detergent section sprayer in flow communication with the detergent water line. The detergent section sprayer is configured to spray water from the detergent water line over the substrate surface when the substrate is positioned over the detergent section of the wash tank. A waste line is in flow communication with the detergent section. A transport unit is configured to advance the substrate from a position outside the wash tank through the wash tank and into the rinse tank section.

Detailed embodiments further comprise at least one metering device in flow communication with one or more of the clean water source, the detergent source and the waste line.

### BRIEF DESCRIPTION OF THE DRAWINGS

A more particular description of the invention, briefly summarized above, may be had by reference to the embodiments thereof that are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an washing circuit according to one or more embodiment of the invention; and

FIG. 2 illustrates a washing system according to one or more embodiments of the invention.

### DETAILED DESCRIPTION

Before describing several exemplary embodiments of the invention, it is to be understood that the invention is not limited to the details of construction or process steps set forth in the following description. The invention is capable of other embodiments and of being practiced or being carried out in various ways.

The detergent mixing circuits of the embodiments described herein rely on balancing the amount of clean process water and detergent concentration. In one or more embodiments, the volume of mixed solutions is used to control concentration of the detergent in a continuous in-line process environment. The systems and methods described are particularly useful for washing glass for single and tandem junction silicon solar cell TCO glass. However, other substrate materials can be cleaned by the described embodiments, and the invention should not be limited to such materials.

The mixing control circuits of the various embodiments described control two functions at once: (1) to supply an adequate amount or volume of clean water to the rinse tank; and (2) to supply an adequate amount or volume of detergent to the tank.

Based on experiments and observation, the supply of DI water can vary in the range of about 3 and 25 L/min. This volume is satisfactory for cleaning 20-30 sheets of 2.6 m×2.2 m silicon dioxide glass substrates. However, these volumes, number and sizes of sheets should not be taken as limiting the scope of the invention.

The water is supplied by using an overflow tank from a final rinse process (water in excess of the capacity of the final rinse tank) which is pumped to the detergent was section. This water is mixed with recirculated water from the detergent wash tank. The amount of water cascaded in is set to provide an overflow in the second tank, which is then disposed of.

The rate of waste water (less the amount of water evaporating from the detergent wash tank) is carefully controlled and detergent is introduced as a percentage of the waste water. This keeps a constant concentration of detergent (generally between about 0.25% to about 1%), with a constant rate of incoming clean water. The cascade flow can be balanced by set points on manual valves, programmable valves, manual flow controllers and programmable flow controllers. The detergent is introduced directly into the process water of the detergent clean section via a check valve and mixing is done at the sprayer and by convection in the tank.

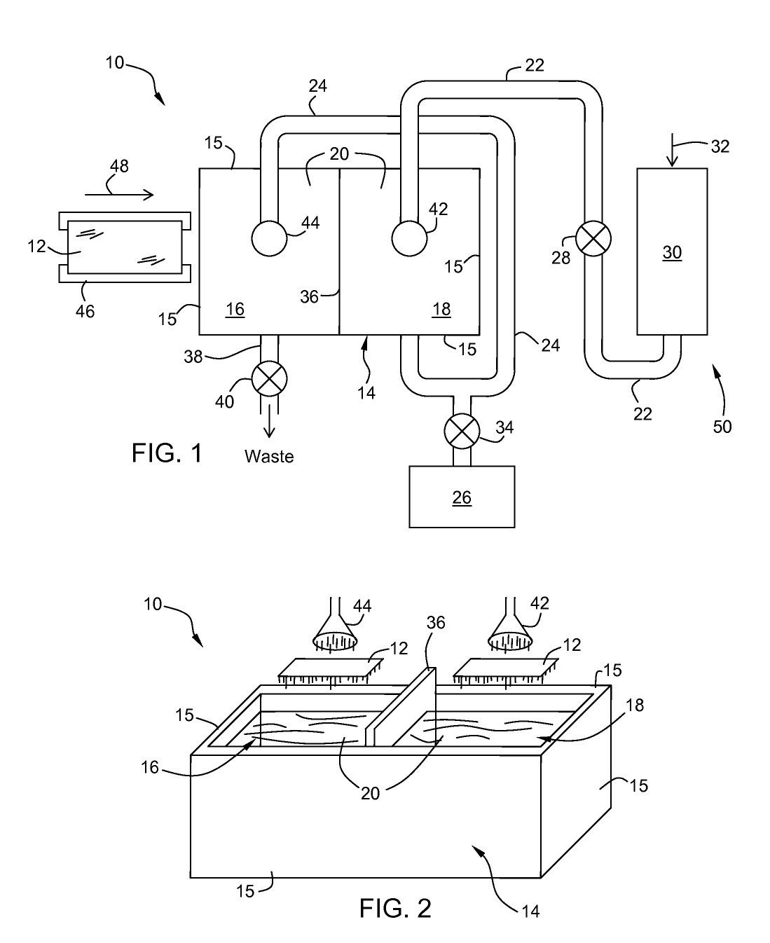

FIGS. 1 and 2 illustrate exemplary embodiments of the inventive washing circuit and apparatus 10 for cleaning substrates 12. The apparatus 10 comprises a wash tank 14 having a detergent wash section 16 and a rinse section 18. The wash tank 14 includes a plurality of walls 15 defining a wash tank area 20. An incoming water source 22 supplies a flow of water to the rinse section 18 of the wash tank 14. A recirculator 24 (also referred to as a recirculator line) moves water from the rinse section 18 to the detergent wash section 16. A detergent source 26 is in flow communication with the recirculator 24. The detergent source 26 supplies an amount of detergent to the water entering the detergent wash section 16.

To clean the surface of a substrate 12, the substrate 12 is positioned in the detergent wash section 16 of the wash tank 14. The substrate 12 may be placed within the detergent wash section 16 or above the detergent wash section 16, as shown in FIG. 2. Water from a first rinse section 18 is directed to the detergent wash section 16 through the recirculator 24. A detergent from a detergent source 26 is mixed with the water from the first rinse section 18 to make a detergent wash and the surface of the substrate 12 is washed with the detergent wash. The substrate 12 is then positioned in the first rinse section 18 of the wash tank 14. By positioned, it is meant that the substrate 12 is placed within the tank (immersed in liquid) or above the tank. Water from a separate water source 22 is directed to the first rinse section 18. The surface of the substrate 12 is rinsed with water from the separate water source 22.

The plurality of walls 15 can be any suitable shape. The embodiments shown in FIGS. 1 and 2 are of a plurality of walls in a rectangular configuration, but oval, round, square, etc. can be employed.

The detergent concentration in the detergent wash section 16 of some embodiments is maintained in the range of about 0.1% and about 1.5% by volume. In detailed embodiments, the detergent concentration is in the range of about 0.25% to about 1% by volume. In specific embodiments, the detergent concentration is greater than about 0.1%, 0.2%, 0.3%, 0.4%, 0.5%, 0.6%, 0.7%, 0.8%, 0.9% or 1.0%. Detailed embodiments of the invention control the detergent solution by affecting the ratio of detergent to incoming water and/or the percentage of incoming or outgoing water.

In some embodiments, the apparatus 10 further comprises a metering device 28 on the incoming water source 22. The metering device 28 may be configured to control the flow of water added to the rinse section 18 of the wash tank 14.

In a detailed embodiment, the incoming water source 22 comprises a rinse tank 30 (also referred to as a separate rinse tank or second rinse tank) which includes a clean water source 32.

In some embodiments, the detergent source 26 further comprises a detergent metering device 34 configured to control the amount of detergent supplied to the water entering the detergent wash section 16 of the wash tank 14. In specific embodiments, the detergent metering device 34 comprises a dosing pump. The detergent metering device 34 may be connected to one or more of a controller (not shown) and at least one sensor (not shown). These devices being configured to monitor the concentration of detergent in the tanks and adjust the concentration by adding more or less detergent to the tanks.

In some embodiments, the amount of water directed from the first rinse section 18 is determined based on evaporation of water from the detergent wash section 16. The evaporation from the detergent wash section 16 can be determined by any suitable techniques, including, but not limited to, visually observing the level of water in the detergent wash section, measuring the concentration of detergent in the detergent wash section, automated monitoring of liquid levels and metrics based on prior data from similar operating conditions and temperatures.

For example, if a cascade rate of 8 L/min is desired, an evaporative loss may be determined to be about 0.5 L/min, and a detergent concentration of about 0.5% by volume is required. The detergent rate would be set to about 0.5% of 7.5 L/min, or 0.0375 L/min.

In detailed embodiments, a partition 36 separates the detergent wash section 16 of the wash tank 14 from the rinse section 18 of the wash tank 14. In specific embodiments, the partition 36 separating the detergent wash section 16 from the rinse section 18 is taller than at least one wall 15 of the wash tank area 20. The partition 36 being adjacent the rinse section 18 to prevent an overflow of water from the rinse section 18 from entering the detergent wash section 16.

In some embodiments, the detergent wash section 16 further comprises waste line 38 configured to flow water from the detergent wash section 16 of the wash tank 14 to a suitable waste stream. The waste line 38 of some embodiment flows water from the detergent wash section 16 of the wash tank 14 to one or more of a drain or a separate tank (not shown). In specific embodiments, the waste line 38 further comprises a waste metering device 40 configured to control the flow of water through the waste line 38 from the detergent wash section 16 of the wash tank 14.

In one or more embodiments, the apparatus 10 includes a rinse section sprayer 42 in flow communication with the incoming water source 22 and positioned above the rinse section 18 of the wash tank 14. The rinse section sprayer 42 may be configured to spray water from the incoming water source 22 over a surface of a substrate 12 when the substrate 12 is positioned over the rinse section 18 of the wash tank 14. As used in this specification and the appended claims, the term “spray” can refer to any suitable method of causing a solution to cover the surface of the substrate. These methods include, but are not limited to, forceful spraying and dripping methods. Sprayers can have any suitable shape including, but not limited to, showerhead type shapes (e.g., circular, ovular, square) and linear shapes (e.g., a strip of spray nozzles).

Some embodiments of the apparatus further comprise a detergent section sprayer 44 in flow communication with the recirculator 24 and positioned above the detergent wash section 16 of the wash tank 14. The detergent section sprayer 44 may be configured to spray water from the recirculator 24 over a surface of a substrate 12 when the substrate 12 is positioned over the detergent wash section 16 of the wash tank 14.

Detailed embodiments of the apparatus 10 include a transport unit 46 configured to advance 48, or convey, the substrate 12 from a position outside the wash tank area 20 to a position over the detergent wash section 16 of the wash tank 14 to a position over the rinse section 18 of the wash tank 14 and to a second position outside of the wash tank area 20. The transport unit 46 can be sized to carry any suitable substrate. In detailed embodiments, the substrate is 2.6 m×2.2 m, but other sizes can be employed. As used in this specification and the appended claims, the terms, “convey” and “conveying” is used to describe movement of a substrate, not necessarily on a particular type of conveyor. The substrate transport unit 46 can be any suitable unit including, but not limited to, conveyor belts, immersion systems and moving rollers.

Further embodiments of the invention are directed to apparatus 10 for cleaning substrates 12. The apparatus 10 comprises a rinse tank section 50 having a rinse tank 30 and a clean water source 32, the clean water source 32 configured to flow clean water over a substrate 12 positioned in the rinse tank section 50. The apparatus 10 also has a wash tank 14 having a detergent wash section 16 and a rinse section 18. The wash tank 14 having a plurality of walls 15 defining a wash tank area 20 and a dividing wall (or partition 36) separating the detergent wash section 16 from the rinse section 18. A water source 22 (also referred to as a rinse tank water line) is in flow communication with the rinse tank 30. The rinse tank water line 22 configured to flow water from the rinse tank 30 to the rinse section 18 of the wash tank 14. A recirculator 24 line (also called a detergent water line) is in flow communication with the rinse section 18 of the wash tank 14 and is configured to move water from the rinse section 18 to the detergent wash section 16. A detergent source 26 is in flow communication with the recirculator 24 (or detergent water line), the detergent source 26 configured to supply an amount of detergent to the detergent water line (recirculator 24) before the detergent wash section 16 of the wash tank 14. A waste line 38 is in flow communication with the detergent wash section 16 of the wash tank 14.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

What is claimed is:

1. An apparatus for cleaning substrates comprising:
a wash tank having a detergent section and a rinse section, the wash tank having a plurality of walls defining a wash tank area;
a transport unit configured to advance the substrate from a position outside the wash tank area to a position over the detergent section of the wash tank to a position over the rinse section of the wash tank and to a second position outside of the wash tank area;
an incoming water source, the incoming water source supplying a flow of water to the rinse section of the wash tank;
a rinse section sprayer in flow communication with the incoming water source and positioned above the rinse section of the wash tank, the rinse section sprayer configured to spray water from the incoming water source over a surface of a substrate when the substrate is positioned over the rinse section of the wash tank;
a recirculator configured to move water from the rinse section to the detergent section;
a detergent source in flow communication with the recirculator, the detergent source supplying a volume of detergent to the water entering the detergent section; and
a detergent section sprayer in flow communication with the recirculator and positioned above the detergent section of the wash tank, the detergent section sprayer configured to spray water from the recirculator over a surface of a substrate when the substrate is positioned over the detergent section of the wash tank.

2. The apparatus of claim 1, further comprising a metering device on the incoming water source, the metering device configured to control the flow of water added to the rinse section of the wash tank.

3. The apparatus of claim 1, wherein the incoming water source comprises a rinse tank, the rinse tank including a clean water source.

4. The apparatus of claim 1, wherein the detergent source further comprises a detergent metering device configured to control the amount of detergent supplied to the water entering the detergent section of the wash tank.

5. The apparatus of claim 4, wherein the detergent metering device comprises a dosing pump.

6. The apparatus of claim 1, further comprising a partition separating the detergent section of the wash tank from the rinse section of the wash tank.

7. The apparatus of claim 6, wherein the partition separating the detergent section from the rinse section is taller than at least one wall of the wash tank area adjacent the rinse section to prevent an overflow of water from the rinse section from entering the detergent section.

8. The apparatus of claim 1, further comprising a waste line configured to flow water from the detergent section of the wash tank.

9. The apparatus of claim 8, wherein the waste line flows water from the detergent section of the wash tank to one or more of a drain or a separate tank.

10. The apparatus of claim 8, wherein the waste line further comprises a waste metering device configured to control the flow of water through the waste line from the detergent section of the wash tank.

11. A method of cleaning a surface of a substrate, the method comprising:
conveying the substrate through a washing apparatus including a detergent wash section and a first rinse section;
directing water from the first rinse section to the detergent wash section;
mixing a detergent with the water from the first rinse section to make a detergent wash;
washing the surface of the substrate with the detergent wash;
positioning the substrate in the first rinse section;
directing water to the first rinse section from a separate water source; and
rinsing the surface of the substrate with water from the separate water source.

12. The method of claim 11, wherein the separate water source is a separate rinse section.

13. The method of claim 11, wherein washing the surface of the substrate with the detergent wash comprises forcefully spraying the detergent wash over the surface.

14. The method of claim 11, wherein rinsing the surface of the substrate comprises forcefully spraying water over the surface.

15. The method of claim 11, wherein an amount of water directed from the first rinse section is determined based on evaporation of water from the detergent wash section.

16. An apparatus for cleaning substrates comprising:
a rinse tank section having a rinse tank and a clean water source, the rinse tank section including a rinse tank sprayer in flow communication with the clean water source, the rinse tank sprayer configured to spray water over a surface of a substrate when the substrate is positioned over the rinse tank;
a wash tank having a detergent section and a rinse section, the wash tank having a plurality of walls defining a wash tank area and a dividing wall separating the detergent section from the rinse section;
a rinse tank water line in flow communication with the rinse tank, the rinse tank water line including a rinse section sprayer in flow communication with the rinse tank water line, the rinse section sprayer configured to spray water over the substrate surface when the substrate is positioned over the rinse section of the wash tank;
a detergent water line in flow communication with the rinse section of the wash tank and configured to move water from the rinse section to the detergent section;
a detergent source in flow communication with the detergent water line, the detergent source including a detergent section sprayer in flow communication with the detergent water line, the detergent section sprayer configured to spray water from the detergent water line over the substrate surface when the substrate is positioned over the detergent section of the wash tank;
a waste line in flow communication with the detergent section; and
a transport unit configured to advance the substrate from a position outside the wash tank through the wash tank and into the rinse tank section.

17. The apparatus of claim 16, further comprising at least one metering device in flow communication with one or more of the clean water source, the detergent source and the waste line.
